(19) United States
(12) Patent Application Publication
(10) Pub. No.: US 2008/0037489 A1
(43) Pub. Date: Feb. 14, 2008

(54) System and method for intelligent media recording and playback on a mobile device

(76) Inventor: Ahmed Adil Yitiz, San Diego, CA (US)

Correspondence Address: PATENTS+TMS, P.C., 2849 W. ARMITAGE AVE., CHICAGO, IL, 60647, US

(21) Appl. No.: 11/807,865

(22) Filed: May 30, 2007

Related U.S. Application Data
(60) Provisional application No. 60/836,828, filed on Aug. 10, 2006.

(51) Int. Cl. H04Q 7/24

(52) U.S. Cl. 370/338

(57) ABSTRACT

A system and a method for intelligent media recording and playback on a mobile device are provided. The system and the method for intelligent media recording and playback on a mobile device have a transmitter for receiving the media and/or metadata which is associated with the media. The transmitter sends and/or transmits the media and/or the metadata to a first memory, a second memory, a first output device and/or a second output device. The memories record, save and/or store the media and/or the metadata. The memories automatically record and/or save the media and/or the metadata when the mobile device is engaged in a function different from outputting the media and/or the metadata. In addition, the memories transmit and/or send the media and/or the metadata to the output devices which display, broadcast and/or play the media and/or the metadata.

This application claims the benefit of U.S. Provisional Patent Application Ser. No. 60/836,828, filed on Aug. 10, 2006.

### BACKGROUND OF THE INVENTION

The present invention generally relates to a system and a method for intelligent media recording and playback of multiple media sources on a mobile device. More specifically, the present invention relates to a system and a method for automatically recording one or more audio and/or video transmissions on a memory to account for the multitasking inherent in mobile devices.

The system may have a first receptor and/or a second receptor for receiving and/or for amplifying the media. A filter may be connected to the system. The filter may convert the media from an analog format to a digital format, may decode the media and/or may filter interference which may be received with the media. The receptor and/or the filter may transmit and/or may transfer the media in, for example, the digital format to a first memory and/or a second memory which may record, may store and/or may save the media. A processor may control and/or may access the first memory and/or the second memory. A first output and/or a second output may transmit, may display and/or may broadcast the media from the receptor, the filter, the first memory and/or the second memory.

It is generally known to transmit and/or to send media from a first location to a second location which is remote to the first location. The media may be transmitted from a first location to a satellite and/or a ground repeater. Next, the satellite and/or the ground repeater may transfer the media to a device. For example, it is generally known to transmit media, such as, for example, an audio transmission and/or a video transmission from a first location to a device which is remote from the first location. The device may be a portable media player, such as, for example, a computer, a radio tuner, a cellular telephone, a personal digital assistant and/or the like. The radio tuner may be, for example, a satellite radio tuner and/or an AM/FM radio tuner. The device may have a single receptor, such as, for example, an antenna for receiving the media content from the first location.

The media may be received from the first location and output to a display screen, speakers, headphones and/or the like. The media may be an audio transmission and/or a video transmission. The device such as, for example, a radio tuner, a satellite radio tuner and/or a cellular telephone receives the audio transmission and/or video transmission via an antenna. The audio transmission and/or the video transmission is output via speakers and/or a display screen.

However, the device merely continuously outputs media content as the media is received by the device. The device does not have a memory for storing and/or recording the media as the media is received by the device. Accordingly, the device merely outputs the media as the media is received without recording and/or without saving the media content.

Moreover, portable devices may have multiple uses and/or multiple functions in addition to the consumption of media, such as, for example, placing telephone calls and/or sending and/or receiving messages. In order to use other functions of the portable device, the user must stop a first function before initiating a second function, such as, for example, placing and/or receiving a telephone call. As a result, the user is unable to consume a portion of the media which was broadcasted while the user was engaged in the second function of the portable device.

In addition, users of portable devices may often be in public settings where interruptions and/or interferences of the media are common. For example, a user may be using the device on a bus or a subway train. When the user arrives at a stop, the user is interrupted from consuming the media while the user exits the train. When the media is being transmitted to the user in real-time, the user cannot later consume a portion of the media which was transmitted while the user was interrupted. As a result, the user may be unable to consume critical parts of live media due to interruptions and/or a need to engage in other functions of the mobile device. Therefore, the consumption of media is inconvenient for the user of the device.

In addition, portable devices may receive one of many media. Accordingly, users of portable devices have a number of media to select and/or to choose to consume at any given time. However, users may want to consume a multiple number of media simultaneously. For example, a user may wish to record a live television broadcast at the same time that the user is listening to music on the portable device. Alternatively, two users may want to share a portable device where a first user consumes a first media and a second user consumes a second media. Currently, users can only consume a single media at any given time. Alternatively, users may merely switch back and forth to consume portions of each media being received by the portable devices.

In each of these examples, users would prefer a portable device that was intelligent and that would automatically record the media during the period when consumption was interrupted, whether by a physical interruption, by a different mode and/or function of the portable device or by the consumption of a different media transmission for later consumption by the user of the portable device.

A need, therefore, exists for a system and a method for intelligent media recording and playback on a mobile device. Additionally, a need exists for a system and a method for intelligent media recording and playback on a mobile device which may record and/or may save the media while simultaneously outputting the media. Further, a need exists for a system and a method for intelligent media recording and playback on a mobile device which may have a first memory and a second memory for recording and/or saving the media. Still further, a need exists for a system and a method for intelligent media recording and playback on a mobile device which may have a first memory and a second memory which may record and/or save a first media and a second media, respectively.

Moreover, a need exists for a system and a method for intelligent media recording and playback on a mobile device which may have a first output and a second output. Furthermore, a need exists for a system which may have a first output for outputting media from a first memory and a second output for outputting media from a second memory. In addition, a need exists for a system and a method for intelligent media recording and playback on a mobile device which may store the media content as the media is output from the mobile device. Further, a need exists for a system and a method for intelligent media recording and playback on a mobile device which may output a first media to a first user and a second media to a second user. Still further, a need exists for a system and a method for intelligent media recording and playback on a mobile device which may have a first receptor and a second receptor for receiving the media.

### SUMMARY OF THE INVENTION

The present invention relates to a system and a method for intelligent media recording and playback on a mobile device. More specifically, the system and the method for intelligent media recording and playback on a mobile device may have a first receptor and/or a second receptor which may receive, may amplify and/or may convert the media. The first receptor may transmit and/or may send the media to a first memory and/or a second memory. A second receptor may transmit and/or may send the media to the first memory and/or the second memory. A filter may be in communication with the receptor, the first memory and/or the second memory. The filter may convert the media from an analog format to a digital format.

A processor may be connected to and/or may be in communication with the first memory and/or the second memory. The processor may control and/or may access the media from the first memory and/or the second memory via an user interface. The first memory and/or the second memory may automatically record the media when the system and/or the mobile device is used for a function other than consuming the media. A first output and/or a second output may output the media content from the memories, the receptors and/or the filter.

It is, therefore, an advantage of the present invention to provide a system and a method for intelligent media recording and playback of multiple media sources on a mobile device which may have a first memory and a second memory.

Another advantage of the present invention is to provide a system and a method for intelligent media recording and playback of multiple media sources on a mobile device which may have a first receptor and a second receptor for receiving the media content.

And, another advantage of the present invention is to provide a system and a method for intelligent media recording and playback of multiple media sources on a mobile device which may have a first output and a second output for outputting the media.

Yet another advantage of the present invention is to provide a system and a method for intelligent media recording and playback of multiple media sources on a mobile device which may store and/or may record the media while a user simultaneously engages in other tasks and/or functions of the mobile device.

A further advantage of the present invention is to provide a system and a method for intelligent media recording and playback of multiple media sources on a mobile device which may have a first output for outputting media content from a first memory and a second output for engaging in a function from a second memory of the mobile device.

Moreover, another advantage of the present invention is to provide a system and a method for intelligent media recording and playback of multiple media sources on a mobile device which may automatically store media as the media is output by the mobile device.

Another advantage of the present invention is to provide a system and a method for intelligent media recording and playback of multiple media sources on a mobile device which may pause and/or may stop the media from transmitting to an output while simultaneously and/or automatically saving the media content to a memory.

And, another advantage of the present invention is to provide a system and a method for intelligent media recording and playback of multiple media sources on a mobile device which may store the media on a first memory while outputting media from a second memory.

Another advantage of the present invention is to provide a system and a method for consuming media content which may output a first media to a first user and a second media to a second user.

A still further advantage of the present invention is to provide a system and a method for consuming media which may have a processor for controlling a memory to store the media at a scheduled time.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system having a memory and an output in an embodiment of the present invention.

FIG. 2 illustrates a black box diagram of a system having a first memory and a second memory in an embodiment of the present invention.

### DETAILED DESCRIPTION OF THE PREFERRED EMBODIMENTS

The present invention relates to a system and a method for intelligent media recording and playback of multiple media sources on a mobile device. The system and the method for intelligent media recording and playback of multiple media sources on a mobile device may have a first receptor and/or a second receptor to receive the media content from a transmitter. The first receptor and/or the second receptor may transmit and/or may send the media to a first memory and/or a second memory which may store, may save and/or may record the media. The receptors may convert the media from, for example, an analog format to a digital format. The second memory may store and/or may save a second media while the first memory transmits a first media to a first output device. In addition, the second memory may automatically save the media while the mobile device is engaged in a function via the first memory. The first receptor and/or the second receptor may transmit and/or may send the media to a first output device and/or a second output device. A processor may access and/or may control the memories and/or the receptors.

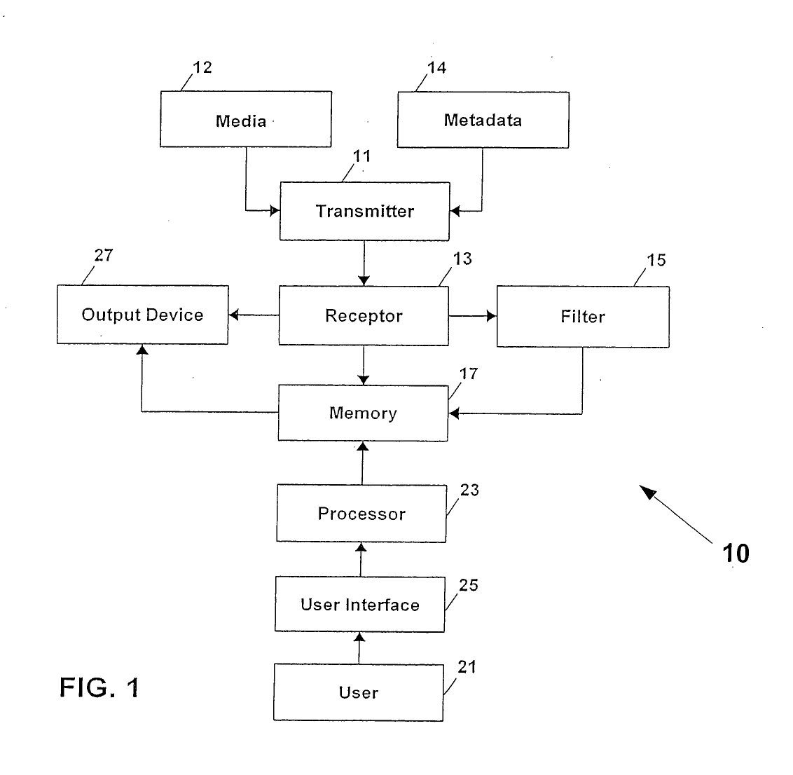

Referring now to the drawings wherein like numerals refer to like parts, FIG. 1 illustrates a black box diagram of a system 10 which may have a transmitter 11. The system 10 may be incorporated into and/or may be in communication with a mobile device (not shown), such as, for example, a laptop computer, a cellular telephone, a personal digital assistant, a radio tuner, a digital media player, a computer, a radio and/or the like. The system 10 may be incorporated into and/or may be in communication with other devices, such as, for example, cable boxes, televisions, audio receivers, computers and/or the like.

The transmitter 11 may be a satellite, an antenna, an infrared transmitter, a WiFi transmitter, a radio signal transmitter, an analog transmitter, a ground transmitter and/or the like. The transmitter 11 may be any device for transmitting media as known to one of ordinary skill in the art.

The transmitter 11 may send and/or may transmit media 12, such as, for example, data transmissions, video transmissions and/or audio transmissions. The media 12 may be digital media files, such as, for example, audio signals, video frames, data feeds, data streams, musical compositions, radio programs, audio books, audio programs, television programs, public access programs, movies, music videos, animated works, video programs, video games, soundtracks and/or video tracks of audiovisual works, dramatic works, film scores and/or operas and/or the like.

In addition, the transmitter 11 may send and/or may transmit, for example, metadata 14. In an embodiment, the metadata 14 may be sent with and/or may be transmitted with the media 12. The metadata 14 may be, for example, a communication and/or information which may be associated with, may relate to and/or may correspond to the media 12. The communication may be, for example, text, a graphic, a video recording, a conferencing recording, a comment, a note, a review, a correspondence, a commentary, a message, a discussion, a notice, a bulletin, a memorandum, news and/or the like. The information may be, for example, a year of the media 12, a publisher or a copyright owner of the media 12, a genre associated with the media 12, a length of time of the media 12, an artist associated with the media 12, a date of creation, publication and/or broadcast and/or the like.

A receptor 13 may connect to and/or may be in communication with the transmitter 11. The receptor 13 may be, for example, an antenna, a sensor, a wireless card and/or the like. The receptor 13 may be any device which may receive media 12 and/or metadata 14 as known to one having ordinary skill in the art.

The metadata 14 and/or the media 12 may be received by the receptor 13. The receptor 13 may receive and/or may accept multiple transmissions, channels and/or stations of the media 12 and/or metadata 14 simultaneously. The media 12 and/or the metadata 14 may be transmitted in a first frequency. The receptor 13 may amplify the metadata 14 and/or the media 12 from the second frequency to the first frequency. The first frequency may be greater and/or higher than the second frequency. The receptor 13 may reduce the media 12 and/or the metadata 14 from the first frequency to the second frequency.

The receptor 13 may convert and/or may transform the metadata 14 and/or the media 12 from a first signal to a second signal. The first signal and/or the second signal may be, for example, a radio wave, an infrared signal, a WiFi signal, an electrical signal and/or the like. The second signal may be different and/or distinct from the first signal.

The receptor 13 may be connected to and/or may be in communication with a filter 15. The media 12 and/or the metadata 14 may be transmitted to and/or may be sent to the filter 15. Alternatively, the media 12 and/or the metadata 14 may be transmitted directly to a memory 17.

The filter 15 may change the media content 12 and/or the metadata 14 from a first format to a second format. For example, the filter 15 may change the media content 12 and/or the metadata 14 from an analog format to a digital format. Furthermore, the filter 15 may prevent and/or may block the media 12 and/or the metadata 14 from passing and/or transmitting to the memory 17. In addition, the filter 15 may store data, such as, for example, subscription information, rating requirements, an amount of the media 12 and/or the metadata 14 transmitted by the filter 15 and/or the like. The memory 17 may be prevented and/or may be blocked from receiving the media 12 and/or the metadata 14 based on, for example, the subscription information, the rating requirements, the amount of the media 12 and/or the metadata 14 transmitted by the filter 15 and/or the like.

In an embodiment, the filter 15 may decode and/or may transmit the metadata 14 and/or the media 12 which was purchased and/or subscribed to by a user 21. The filter 15 may be controlled remotely. For example, a provider (not shown) may change and/or may edit, for example, the subscription information of the filter 15.

The transmitter 11 may send and/or may transmit media 12 and/or the metadata 14 having, for example, interference, such as, for example, static, noise, disturbance, interruption and/or the like. The filter 15 may adjust, may filter and/or may modify the media 12 and/or the metadata 14 by, for example, removing, changing and/or reducing the interference.

The receptor 13 may be connected to and/or may be in communication with the memory 17. To this end, the receptor 13 may transmit and/or may send the media 12 and/or the metadata 14 to the memory 17. The receptor 13 may transmit and/or may send the media 12 and/or the metadata 14 to an output device 27.

The metadata 14 and/or the media 12 may be stored, may be recorded and/or may be saved in the memory 17 which may be, for example, a storage device, such as, for example, a hard drive, a flash drive, a holographic memory device, a floppy disc, a digital versatile disc, a compact disc, a memory card and/or the like. The memory 17 may be, for example, a disc drive, such as, for example, a floppy disc drive, a compact disc drive, a digital video disc drive and/or the like. The media 12 and/or the metadata 14 may be saved, recorded and/or stored in the memory 17 as the media 12 and/or the metadata 14 are transmitted to the output 27.

In an embodiment, the memory 17 may record a predetermined size, amount, length and/or time of the media 12 and/or the metadata 14. If the predetermined size of the media 12 and/or the metadata 14 is reached, and an additional amount of the media 12 and/or the metadata 14 is received by the memory 17, then the memory 17 may record and/or store the additional amount of the media 12 and/or the metadata 14 in place of the media 12 and/or the metadata 14 which was transmitted, for example, at an earliest time and/or date. For example, the memory 17 may record, for example, one hour of the media 12 and/or the metadata 14. After the hour, the metadata 14 and/or the media 12 may be received by the memory 17 may be recorded and/or may be saved in place of the metadata 14 and/or the media 12 which was received at, for example, a beginning of the hour. The memory 17 may be limited to recording and/or to saving the media 12 and/or the metadata 14 by, for example, a size and/or a capacity of the memory 17. The present invention should not be deemed as limited to a certain size, amount, length and/or time of recording and/or saving of the media 12 and/or the metadata 14. The memory 17 may record any amount, size, time and/or length of the media 12 and/or the metadata 14 as known to one having ordinary skill in the art.

The memory 17 may store and/or may record the media 12 and/or the metadata 14 without interaction and/or communication from the user 21. The media 12 and/or the metadata 14 may be transmitted to the output 27 via the memory 17. As a result, the memory 17 may record and/or may store the metadata 14 and/or media 12 as the media 12 and/or the metadata 14 are transmitted to the output 27. In an embodiment, the memory 17 may record and/or may save the media 12 and/or the metadata if the user 21 is remote with respect to the memory 17 and/or without interaction by the user 21.

Moreover, the system 10 and/or the mobile device (not shown) may have multiple uses and/or multiple functions in addition to the consumption of the media 12, such as, for example, placing and/or receiving a telephone call, transmitting and/or receiving a data signal, transmitting and/or receiving a text message, transmitting and/or receiving electronic mail, accessing a network, accessing the Internet, displaying and/or modifying a calendar, setting and/or changing an alarm, playing and/or engaging in a video game and/or the like. The system 10 and/or the mobile device may perform a first function, such as, for example, placing a telephone call while simultaneously receiving and/or saving the media 12. In an embodiment, the system 10 and/or the mobile device may automatically record and/or may automatically save the media 12 when the user 21 engages in one of the functions.

Furthermore, the user 21 may control, may access and/or may communicate with the memory 17 via a processor 23 and/or an user interface 25. The memory 17 may transmit and/or may send the media 12 and/or the metadata 14 to the output device 27 as the memory 17 stores and/or records the media 12 and/or the metadata 14. As a result, the user 21 may consume the media 12 and/or the metadata 14 while the memory 17 stores and/or records the media 12 and/or the metadata 14.

To this end, the user 21 may access the media 12 and/or the metadata 14 which was transmitted to the memory 17 at, for example, an earlier time. In addition, the user 21 may access the media 12 which was transmitted when, for example, the user 21 was engaged in a different function of the mobile device. Accordingly, the user 21 may control the memory 17 to transmit the media 12 previously sent to the output device 27. For example, the user 21 may fail to hear and/or to see the media 12 as the media 12 is transmitted to the output device 27. The user 21 may fail to consume the media 12 due to, for example, engaging in a different function of the mobile device and/or being interrupted while consuming the media 12. Therefore, the user 21 may control the memory 17 to transmit the media 12 which was received at an earlier time such as, for example, forty-five minutes ago, to the output device 27.

In an embodiment, the processor 23 may control the memory 17 to record and/or to save the media 12 and/or the metadata 14. The user 21 may interact with and/or may control the processor 23 via the user interface 25. The processor 23 and/or the memory 17 may be controlled and/or may be programmed to record, to save and/or to store the media 12 and/or the metadata 14 in the memory 17. The processor 23 may control the memory 17 even if the user 21 is remote with respect to the user interface 25. For example, the memory 17 may record and/or may store the media 12 and/or the metadata 14 at a time requested by the user 21.

In addition, the user 21 may program and/or may control the memory 17 to record the metadata 14 and/or the media 12 based on information relating to the metadata 14 and/or the media 12, such as, for example, a time, a name, a title, a rating, a description, a content, an artist, a singer, an actor, an actress, a director, a composer and/or the like. The user 21 may program and/or may control the memory 17 to record and/or to save the media 12 and/or metadata 14 based on any information known to one having ordinary skill in the art.

The memory 17 may receive multiple transmissions, for example, channels and/or stations of the media 12 and/or the metadata 14 simultaneously or substantially simultaneously. The user interface 25 may be used to select and/or to choose a transmission to consume. The output device 27 may display information relating to the media 12 and/or the metadata 14, such as, for example, a channel, a station, a broadcast location and/or the like.

The memory 17 may transmit and/or may send the media 12 and/or the metadata 14 to the output device 27 which may broadcast, may display and/or may sound the media 12 and/or the metadata 14. The output device 27 may be an audio speaker, headphones, a display screen, a monitor, a television, car audio speakers and/or the like.

The output device 27 may transmit, may display and/or may broadcast the media 12 and/or the metadata 14 which may be, for example, a video transmission and/or an audio transmission. The video transmission may be a movie, a television show, a commercial, a video game, a news show, a weather report, sports highlights, a musical video, a sporting event, entertainment news, a debate, a game show, a comedy show, a movie trailer, an opera, an interactive game and/or the like. Furthermore, the video transmission may be text, such as, for example, a graphic, a description, a song title, a name of a composer, a name of an artist, a name of an actress, a name of an actor, a comment, a note, a review, news, scores and/or the like. The audio transmission may be sound associated with and/or related to the video transmission, such as, for example, a song, a dialogue, a narrative, a conversation, a speech and/or the like. The output device 27 may output the video transmission and/or the audio transmission.

In an embodiment, the output device 27 may display the video transmission and simultaneously output the audio transmission. For example, the output device 27 may output a song and simultaneously display text and/or graphics, such as, for example, a title of the song, a singer of the song, a year of the song, an album name of the song, a video of the song, a picture of an artist of the song and/or the like.

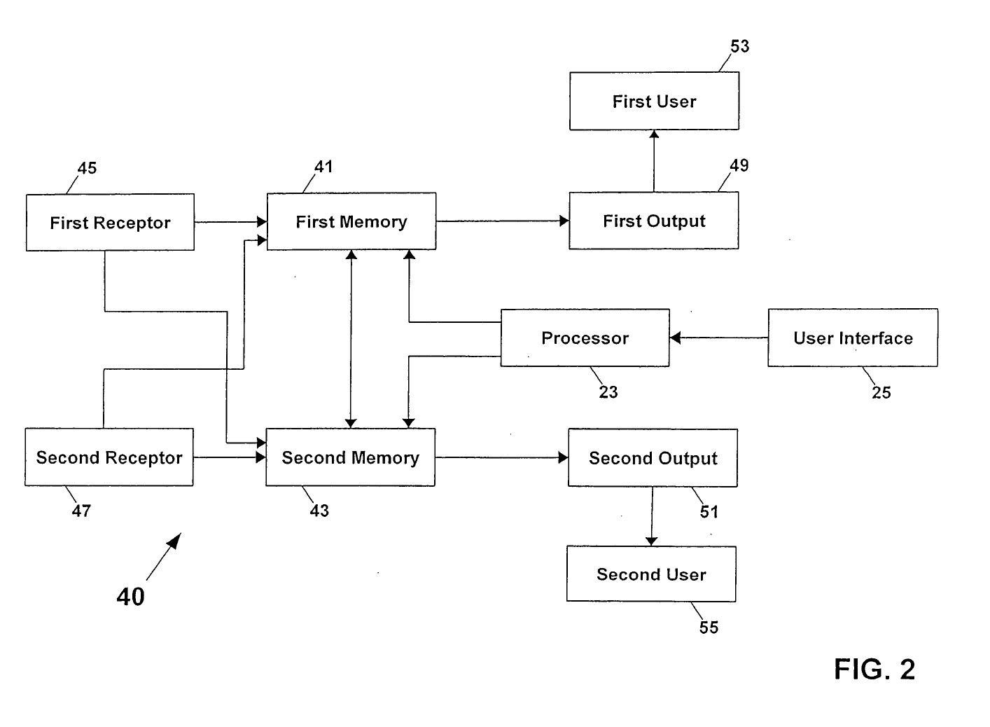

FIG. 2 illustrates an embodiment of the invention having a system 40 which may have a first memory 41 and a second memory 43. The first memory 41 may be connected to and/or may be in communication with the second memory 43. The metadata 14 and/or the media 12 may be transferred from, may be sent from and/or may be transmitted from the first memory 41 to the second memory 43 and/or from the second memory 43 to the first memory 41.

In an embodiment, the first memory 41 may record and/or may store the media 12 and/or the metadata 14 as the media 12 and/or the metadata 14 is received by the first memory 41. The first memory 41 may transmit and/or may send the media 12 and/or the metadata 14 to a first output device 49 and/or a second output device 51 as the first memory 41 stores and/or records the media 12 and/or the metadata 14. The second memory 43 may store and/or may save the metadata 14 and/or the media 12 which is recorded and/or saved as a result of, for example, a command and/or a communication from the user 21, as illustrated in FIG. 1.

Furthermore, the system 40 may have other uses and/or other functions in addition to the consumption of the media 12. For example, the system 40 may be used to place and/or to receive a telephone call, to transmit and/or to receive a text message and/or the like. The system 40 may be used to perform any function capable of being performed on a mobile device and/or a portable device as known to one having ordinary skill in the art.

In an embodiment, the first memory 41 may automatically record and/or may automatically save the media 12 when the user 21 engages in a function different from consuming the media 12. To this end, the second memory 43 may be accessed, may be manipulated and/or may be used to engage in the function while the first memory 41 saves and/or records the media 12. To this end, the first user 53 and/or the second user 55 may consume the media 12 after, for example, completing the function.

In such an embodiment, the first user 53 may consume the media 12 which may be a live and/or a streaming video transmission. The first user 53 may receive, for example, a telephone call while the live and/or the streaming video transmission is received by the first memory 41 and/or the second memory 43. The first user 53 may answer the telephone call and simultaneously and/or substantially simultaneously the first memory 41 and/or the second memory 43 may save and/or may record the live and/or the streaming video transmission of the media 12. The first user 53 may complete the telephone call and begin consuming the media 12 from a time in which the first user 53 accepted the telephone call. To this end, the system 40 may be used to engage in multiple functions while saving and/or recording the media 12 for consumption at a later time.

As FIG. 2 illustrates, the first memory 41 may transmit the media 12 and/or the metadata 14 to the first output 49. The second memory 43 may transmit the metadata 14 and/or the media 12 to the second output 51. A first user 53 may consume the media 12 and/or the metadata 14 via the first output 49. A second user 55 may consume the media 12 and/or the metadata 14 via the second output 51. The first user 53 may be remote with respect to the second user 55.

The first user 53 and/or the second user 55 may consume the media 12 and/or the metadata 14 by viewing, listening to, interacting with, reading, manipulating, modifying, displaying and/or broadcasting the media 12 and/or the metadata 14. In addition, the users 53, 55 may exchange, share and/or modify the media 12 and/or the metadata 14. In an embodiment, the users 53, 55 may view the metadata 14 and listen to the media 12. The users 53, 55 may read and/or may review the metadata 14 prior to consuming the media 12.

The first memory 41 and/or the second memory 43 may transmit and/or may send the media 12 and/or the metadata 14 to the first output 49 and the second output 51. As a result, the users 53,55 may consume the media 12 and/or the metadata 14 which may be transmitted by and/or stored in the first memory 41 and/or the second memory 43. The present invention should not be deemed as limited to two memories and/or two outputs. The present invention may incorporate any number of outputs and/or memories as known to one of ordinary skill in the art.

The first memory 41 may be remote with respect to the second memory 43. The first memory 41 and/or the second memory 43 may be, for example, portable, such as, for example, a flash drive, a memory card, a digital versatile disc, a floppy disk and/or the like.

In addition, the first memory 41 and/or the second memory 43 may store data necessary for the operation of the system 40. The transmitter 11 may send and/or may transmit, for example, updates to the data, additional data and/or replacement data related to the operation of the system 40. The first memory 41 and/or the second memory 43 may store and/or may receive information, such as, for example, a guide, a chart, a list of media 12 and/or the metadata 14 which may be received by a first receptor 45 and/or a second receptor 47 at a future time. Moreover, the output devices 49, 51 may display, for example, a programming guide illustrating the media 12 which may be received by the receptors 45,47 and/or which may be sent by the transmitter 11.

Furthermore, the memories 41,43 may be limited in storage capacity, size, length and/or the like. If the first memory 41 and/or the second memory 43 reaches capacity, then the first receptor 45 and/or the second receptor 47 may send the media 12 and/or the metadata 14 directly to the output devices 49, 51. Alternatively, the memories 41,43 may record and/or may store the media 12 and/or the metadata 14 in place of the media 12 and/or the metadata 14 which was recorded and/or stored, for example, earliest in time. In an embodiment, additional streams and/or transmissions of the media 12 and/or the metadata 14 may replace the metadata 14 and/or the media 12 that may have been previously recorded by, for example, priority. For example, the user 21 may input information and/or data to list and/or to categorize the media 12 and/or the metadata 14 from most important to least important. To this end, the media 12 and/or the metadata 14 which may be least important may be replaced by additional streams and/or transmissions of the media 12 and/or the metadata 14.

A first receptor 45 and/or a second receptor 47 may transmit and/or may send the media 12 and/or the metadata 14 to the first memory 41 and/or the second memory 43. The first receptor 45 and/or the second receptor 47 may receive the media 12 and/or the metadata 14 from the transmitter 11 as illustrated in FIG. 1. The present invention should not be deemed as limited to a number of receptors. The present invention may incorporate any number of receptors as known to one of ordinary skill in the art.

As illustrated in FIG. 2, the first receptor 45 and/or the second receptor 47 may transmit and/or may send the media 12 and/or the metadata 14 directly to the first output device 49 and/or the second output device 51. The receptors 45, 47 may send and/or may transmit the media 12 and/or the metadata 14 to the output devices 49, 51 and the memories 41, 43. In an embodiment the first receptor 45 and/or the second receptor 47 may convert the media 12 and/or the metadata 14 from a first format to a second format. For example, the first receptor 45 and/or the second receptor 47 may convert the media 12 and/or the metadata 14 from an analog format to a digital format.

The processor 23 may control and/or may access the first memory 41 and/or the second memory 43. The processor 23 may be in communication with and/or connected to the user interface 25 which may command and/or may control the memories 41,43 and/or the output devices 49,51. The processor 23 may be programmed and/or may be controlled by a provider (not shown) of the media 12 and/or the metadata 14 and/or the user 21. The processor 23 may operate and/or may function based on, for example, data and/or software which may be stored on the first memory 41 and/or the second memory 43.

The metadata 14 and/or the media 12 may be, for example, a live audio and/or a live video transmission. The media 12 and/or the metadata 14 may be continuously transmitted and/or constantly transmitted to the first receptor 45 and/or the second receptor 47. To this end, the media 12 and/or the metadata 14 may be, for example, a streaming transmission.

The metadata 14 and/or the media 12 may have, for example, multiple transmissions, such as, for example, multiple video transmissions and/or multiple audio transmissions. The first memory 41 and/or the second memory 43 may receive, may record and/or may store a first transmission. The first memory 41 and/or the second memory 43 may receive, may record and/or may store a second transmission. To this end, the first memory 41 may output and/or may send the first transmission to the first output device 49 and/or the second output 51. Likewise, the second memory 43 may output and/or may send the second transmission to the first output device 49 and/or the second output device 51. The present invention should not be deemed as limited to a number of transmissions of media and/or metadata. The system 40 may receive and/or may transmit any number of transmissions of the media and/or metadata as known to one of ordinary skill in the art.

The first memory 41 and/or the second memory 43 may receive, may record and/or may store a first streaming transmission and a second streaming transmission of the media 12 and/or the metadata 14. As a result, the first memory 41 and/or the second memory 43 may record and/or may store the first streaming transmission of the media 12 and transmit the second streaming transmission of the media 12 to the first output 49 and/or the second output 51.

The user interface 25 may be, for example, a touch screen, a keyboard, buttons, keys, a computer mouse, a dial, a knob and/or the like. The user 21 may control the processor 23 via the user interface 25. The user 21 may, for example, command the first memory 41 and/or the second memory 43 to record, to save and/or to store the metadata 14 and/or the media 12. The user 21 may input, for example, a command, a communication and/or data to record and/or to save the media 12 and/or the metadata 14.

The first memory 41 and/or the second memory 43 may record and/or may save the media 12 and/or the metadata 14 even if the user 21 is remote with respect to the system 40. For example, the user 21 may input a command and/or a communication via the user interface 25 to control the first memory 41 and/or the second memory 43 at a future time.

The user interface 25 may be utilized to control and/or to access the media 12 and/or the metadata 14 stored in the first memory 41 and/or the second memory 43 via the processor 23. In an embodiment, the metadata 14 and/or the media 12 may be recorded and/or may be saved in the first memory 41 and/or the second memory 43 and simultaneously transmitted to the first output device 49 and/or the second output device 51. The first memory 41 and/or the second memory 43 may record and/or store the media 12 and/or metadata 14 received from the first receptor 45 and/or the second receptor 47. Simultaneously, the first memory 41 and/or the second memory 43 may transmit the media 12 and/or metadata 14 which was received, for example, a certain time ago, via the first output device 49 and/or the second output device 51. To this end, the user interface 25 may be used to, for example, rewind a live transmission of the media 12. The user interface 25 may be used to scan, to scroll, to seek and/or to rewind at, for example, different rates, speeds, amounts of time and/or the like.

Furthermore, the user interface 25 may be used to output the media 12 and/or the metadata 14 which was previously transmitted to the first output 49 and/or the second output 51. The user interface may be utilized to scroll and/or to rewind an amount of time to consume the metadata 14 which was previously transmitted to the output devices 49, 51. In addition, the user interface 25 may rewind a transmission of the media 12 to the transmission of the media 12 which was previously received the memories 41, 43. In an embodiment, the transmission of the media 12 may be rewound, for example, thirty-seconds. The user interface 25 may have controls and/or inputs to rewind any amount of time and/or length. The user 21 may change and/or may modify the amount of time and/or the length of time via the user interface 25.

Moreover, the user interface 25 may be used to scan, to scroll and/or to rewind a streaming transmission of the media 12. To this end, the user 21 may consume a previous part and/or an earlier portion of the streaming transmission of the media 12. The user interface 25 may have conventional controls and/or commands to, for example, scan, scroll, seek and/or to rewind an amount of time from which the media 12 and/or the metadata 14 was received by and/or transmitted by the first receptor 45 and/or the second receptor 47. The user interface 25 may have commands and/or controls to increase and/or decrease a speed and/or a rate of scanning, scrolling, rewinding and/or seeking. To this end, the user 21 may, for example, rewind a live and/or a streaming transmission of the media 12 and/or the metadata 14.

Furthermore, the user interface 25 may be used to scan and/or to seek forward in time and/or in length toward a live and/or currently streaming transmission of the media 12. In an embodiment, the user interface 25 may be used to instantly output a live transmission of the media 12 to the first output device 49 and/or the second output device 51. The user interface 25 may be used to scan and/or to seek forward at, for example, different rates, speeds, amounts of time and/or the like. The first output device 49 and/or the second output device 51 may display the rate and/or the speed.

In addition, the first output device 49 and/or the second output device 51 may display information relating to a location, a time, a length and/or an amount of the media 12 and/or the metadata 14. The information may be and/or may relate to, for example, an amount of a transmission of the media 12 which may be stored in the memories 41, 43. Further, the information may be and/or may relate to the amount of a transmission of the media 12 which may not have been output to the output devices 49, 51. In an embodiment, the information may be, a time difference between a time the media 12 may have been received by the receptors 45, 47 and a time the media 12 may have been transmitted to the output devices 49, 51.

Furthermore, the user interface 25 may be utilized to pause and/or to stop the first memory 41 and/or the second memory 43 from transmitting and/or sending the media 12 to the first output device 49 and/or the second output device 51. As a result, the first memory 41 and/or the second memory 43 may record and/or may save the media 12 transmitted and/or sent by the first receptor 45 and/or the second receptor 47. The user interface 25 may then be used to play and/or to broadcast the media 12 at, for example, a time in which the media 12 was stopped and/or paused. To this end, the user interface 25 may be used to pause and/or to stop, for example, a live transmission and/or a streaming transmission of the media 12 and/or the metadata 14.

The first output device 49 and/or the second output device 51 may display, for example, a length of media 12 which is stored in the first memory 41 and/or the second memory 43. In addition, the first output device 49 and/or the second output device 51 may display, for example, a time in which the media 12 was received by the first receptor 45 and/or the second receptor 47. Furthermore, the output devices 49, 51 may display, for example, a progress bar which may illustrate a time remaining before the output devices 49, 51 are broadcasting the media 12 as the media 12 is received by the receptors 45, 47. To this end, the output devices 49, 51 may display, for example, a time in which a transmission of the media 12 was received.

In an embodiment, the user interface 25 may be utilized to record and/or to save the media 12 and/or the metadata 14 in the first memory 41 and/or the second memory 43 for consumption at, for example, a later time. The first output device 49 and/or the second output device 51 may display the media 12 and/or the metadata 14 which is stored and/or saved on the first memory 41 and/or the second memory 43. The output devices 49, 51 may list the media 12 and/or the metadata 14 by, for example, a title, a length, a channel and/or frequency of recording, a date and/or a time recorded to the memories 41, 43, an artist, a composer, an actress, an actor, a type of media 12 and/or the like. The output devices 49, 51 may categorize the media 12 by, for example, a style, a time period, a type and/or the like.

The user interface 25 may have conventional features and/or conventional controls, such as, for example, knobs, buttons, keys and/or switches to navigate and/or to control the output devices 49, 51 and the memories 41, 43. The user interface 25 may be used to select and/or to choose from the media 12 and/or the metadata 14 which was recorded. To this end, the user interface 25 may be utilized to select the media 12 and/or the metadata 14 in which to transmit to the first output device 49 and/or the second output device 51. Alternatively, the user interface 25 may be used to delete the media 12 and/or the metadata 14 from the first memory 41 and/or the second memory 43.

The first memory 41 and/or the second memory 43 may store and/or may record the media 12 and/or the metadata 14 as, for example, a media file, such as, for example, a video file, an audio file and/or the like. The metadata 14 and/or the media 12 which may be recorded by the first memory 41 and/or the second memory 43 may be output and/or may be transmitted to the first output 49 and/or the second output device 51. The first memory 41 and/or the second memory 43 may record and/or may store the first transmission and simultaneously output the media 12 and/or the metadata 14 which was recorded to the first output device 49 and/or the second output device 51.

Furthermore, the memories 41, 43 may record and/or may store the media 12 and/or the metadata 14 at, for example, a quality level, such as, for example, a bit rate, a frequency, a format and/or the like. The user interface 25 may be utilized to change the quality level of the media 12 and/or the metadata 14 via the processor 23. The quality level of the media 12 and/or the metadata 14 may be changed and/or may be modified for outputting to the output devices 49, 51 and/or to record and/or to save to the memories 41, 43. In an embodiment, the quality level may be changed from an analog format to a digital format.

The media 12 and/or the metadata 14 which may be recorded and/or stored on the memories 41, 43 may be executed and/or selected to transmit to the first output device 49 and/or the second output device 51. The user interface 25 may have conventional features for navigating and/or controlling the media 12 and/or the metadata 14 to the output devices 49, 51.

The user interface 25 may have conventional and/or customary commands and/or controls to rewind, fast forward, pause, stop, play and/or delete the media 12 and/or the metadata 14. In addition, the user interface 25 may rewind and/or fast forward at, for example, different rates and/or different speeds. The output devices 49, 51 may display a rate and/or a speed of fast forwarding and/or rewinding of the media 12 and/or the metadata 14. Furthermore, the output devices 49, 51 may display, for example, a time remaining and/or a time elapsed in a transmission of the media 12 and/or the metadata 14.

The systems 10, 40 may have the first receptor 45 and/or the second receptor 47 for receiving the media 12 and/or the metadata 14 from the transmitter 11. The receptors 45, 47 may transmit and/or may send the media 12 and/or the metadata 14 to the filter 15, the memories 41, 43 and/or the output devices 49, 51. The memories 41,43 may store, may save and/or may record the media 12 and/or the metadata 14 for consumption by the user 21 at a later time. The memories 41, 43 may store and/or may record the media 12 and/or the metadata 14 and transmit and/or send the media 12 and/or the metadata 14 to the output devices 49, 51. The user interface 25 may be utilized and/or manipulated to control and/or to command the processor 23. The user interface 25 and/or the processor 23 may be used to control, to access and/or to manipulate the media 12 and/or the metadata 14 which may be stored and/or may be recorded on the memories 41, 43. In addition, the user interface 25 may have conventional and/or customary controls for controlling the output devices 49, 51 and/or the receptors 45, 47.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for intelligent media recording and playback, the system comprising:
a transmitter that transmits a first media file and a second media file;
a mobile device that has a first receptor in the mobile device wherein the first receptor receives the first media file from the transmitter;
a first output component of the mobile device wherein the first output component obtains the first media file from the first receptor and allows a user to consume the first media file; and
a first memory in the mobile device wherein the second media file is received from the transmitter and transmitted to the first memory wherein the second media file is stored by the first memory if consumption of the first media file is substantially simultaneous with receipt of the second media file.

2. The system of claim 1 wherein the user interface allows the user to program a time for transmission and storage of the first media file.

3. The system of claim 1 further comprising:
a user interface that allows the user to select the second media file for storage and the first media file for consumption if the first media file and the second media file are received substantially simultaneously.

4. The system of claim 1 further comprising:
a user interface that allows the user to pause consumption of the first media file so that an unconsumed portion of the first media file is stored in the first memory.

5. The system of claim 1 further comprising:
a user interface that allows the user to rewind the first media file to view an earlier portion of the first media file.

6. The system of claim 1 further comprising:
a filter in the mobile device wherein the filter converts the second media file from a first format to a second format.

7. The system of claim 1 further comprising:
a second output component in the mobile device wherein the second output component allows the user to consume the second media file on the second output component while the first media file is consumed on the first output component.

8. The system of claim 1 further comprising:
a second receptor in the mobile device wherein the second receptor receives the second media file from the transmitter.

9. The system of claim 1 wherein the output component displays metadata associated with the second media file.

10. The system of claim 1 further comprising:
a second memory wherein the mobile device consumes the second media file from the first memory and substantially simultaneously engages in a function using the second memory.

11. The system of claim 1 further comprising:
a processor connected to the first memory wherein the processor controls the storage of the second media file and the consumption of the first media file.

12. A method for intelligent media recording and playback, the method comprising the steps of:
consuming a first media file on a mobile device;
receiving a second media file on the mobile device as the first media file is consumed;
storing the second media file in a memory of the mobile device;
consuming the second media file on the mobile device; and
controlling consumption of the second media file on the mobile device wherein the mobile device allows the user to rewind the second media file to consume an earlier portion of the second media file, pause the second media file to resume the consumption of the second media file at a later time and forward the second media file to consume a later portion of the second media file.

13. The method of claim 12 further comprising the step of:
programming a time for transmission of the second media file.

14. The method of claim 12 further comprising the step of:
converting the second media file from a first format to a second format.

15. The method of claim 12 further comprising the step of:
consuming the first media file using a first output while the second media file is consumed substantially simultaneously using a second output.

16. A method for intelligent media recording and playback, the method comprising the steps of:
receiving a media file on a mobile device;
consuming a portion of the media file on an output component of the mobile device;
pausing consumption of the media file on the mobile device wherein the media file is stored in a memory of the mobile device; and
resuming consumption of the media file on the output component of the mobile device.

17. The method of claim 16 further comprising the step of:
pausing consumption of the media file if the mobile device engages in a function different than consumption of the media file.

18. The method of claim 16 further comprising the step of:
pausing consumption of the media file if an additional media file is transmitted to the mobile device.

19. The method of claim 16 further comprising the step of:
programming a time for transmission of the media file to the mobile device.

20. The method of claim 16 further comprising the step of:
initiating a second consumption of the media file by transmitting the media file from the memory to the output component of the mobile device.
